(19) United States
(12) Patent Application Publication
(10) Pub. No.: US 2014/0170625 A1
(43) Pub. Date: Jun. 19, 2014

(54) SYSTEM AND METHOD FOR FACILITATING AN INTERACTIVE STORY

(71) Applicant: J-LYNN ENTERTAINMENT, LLC, Cleveland, OH (US)

(72) Inventor: Neadom Tamar Medina, Avon Lake, OH (US)

(73) Assignee: J-LYNN ENTERTAINMENT, LLC, Cleveland, OH (US)

(21) Appl. No.: 13/719,918

(22) Filed: Dec. 19, 2012

(51) Int. Cl. G09B 5/06

(52) U.S. Cl. CPC G09B 5/06
USPC 434/317

(57) ABSTRACT

A method for facilitating an interactive story includes a computer receiving data representative of an event in a story, the event corresponding to a first page number of a book. A computer communicates a task based on the event. A computer receives data representative of a response to the task. A computer determines a next event in the story based on the response. A computer communicates a second page number of the book, the second page number corresponding to the next event in the story.

### PRIORITY

This application claims priority to U.S. Patent Application No. 61/597,923 filed on Feb. 13, 2012. The entirety of that application is incorporated herein.

### FIELD OF INVENTION

The present disclosure relates to the field of books. More particularly, the present invention relates to a system and method for electronically facilitating an interactive story.

### BACKGROUND

Books, and comic books in particular, are traditionally published in paper format. The stories of the books are static, meaning that the story doesn't change once it is published. Some books have been published in a manner in which the reader is able to make choices in the course of a story, with the choices then leading the reader through different versions and endings of the story. However, the reader's ability to interact with the story is limited to making choices in response to options that have been incorporated into the published book.

Books that are published in digital form offer more flexibility in terms of how the story is delivered to the reader and in terms of how the reader interacts with the story. Nevertheless, a reader's experience and level of interactivity with digitally published stories has also been limited to the format in which the book was published.

### SUMMARY OF THE INVENTION

A method for facilitating an interactive story includes a computer receiving data representative of an event in a story, the event corresponding to a first page number of a book. A computer communicates a task based on the event. A computer receives data representative of a response to the task. A computer determines a next event in the story based on the response. A computer communicates a second page number of the book, the second page number corresponding to the next event in the story.

A system for facilitating an interactive story includes at least one processor, at least one computer-readable tangible storage device, and program instructions stored on the at least one storage device for execution by the at least one processor. The program instructions include first program instructions configured to receive data representative of a location in a book. The program instructions include second program instructions configured to communicate data representative of a task, the task being configured to illicit a response. The program instructions include third program instructions configured to receive data representative of a response to the task. The program instructions include fourth program instructions configured to communicate data representative of a next location in the book based on the response.

An interactive electronic book reader includes at least one processor, at least one computer-readable tangible storage device, at least one user interface, and program instructions stored on the at least one storage device for execution by the at least one processor. The program instructions include first program instructions configured to communicate a first portion of a story to the at least one user interface. The program instructions include second program instructions configured to communicate, to the at least one user interface, a game configured to illicit a feedback by way of the at least one user interface. The program instructions include third program instructions configured to communicate a second portion of the story to the at least one user interface based on the feedback.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example system for facilitating an interactive story.

FIG. 2 illustrates another example system for facilitating an interactive story.

FIG. 3 illustrates a block diagram of an example system for facilitating an interactive story.

FIG. 4 is a flow chart illustrating an example method for facilitating an interactive story.

FIG. 5 is a schematic diagram of an example computer for implementing the example system for facilitating an interactive story of FIG. 1.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computer communication,” as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11, IEEE 802.15), an Ethernet system (e.g., IEEE 802.3), a token ring system (e.g., IEEE 802.5), a local area network (LAN), a wide area network (WAN), a point-to-point system, a circuit switching system, a packet switching system, combinations thereof, and so on.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Data store,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel, and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

“Video Game” as used herein refers to various electronic games requiring user interaction, including first person shooter games, racing games, real-time strategy games, quizzes, and so on.

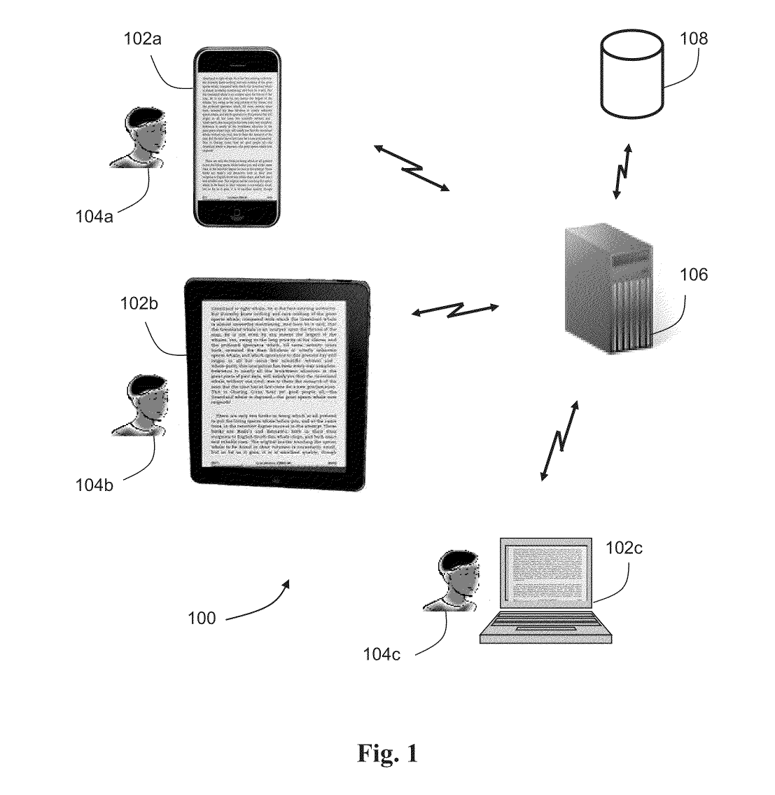

FIG. 1 illustrates an example system 100 for facilitating an interactive story. The system 100 includes one or more computing devices 102a, 102b, and 102c (hereinafter referred to as computing device 102) configured to communicate a story to one or more users 104a, 104b, and 104c (hereinafter referred to as user 104). A story may include text, graphics, or a combination of both. For example, the story may be a comic book, a novel, a graphic novel, a biography, a children's picture book, and so on.

While FIG. 1 illustrates a mobile phone, a tablet computer, and a laptop computer as exemplary computing devices, it should be understood that computing device 102 may be a desktop computer, a laptop computer, a handheld computer, a tablet computer, a server, a mobile phone, an e-reader, a video game console, a television, a DVD player, or any other similar type of device capable of displaying a story to user 104.

System 100 includes a story server 106 configured to communicate with computing device 102 and to enable computing device 102 to provide user 104 with an interactive story experience. Particularly, story server 106 is configured to receive data representative of an event or a location in a story. For example, when user 104 reaches a certain event or page number (or line number, word number, or panel number) in a digital book, computing device 102 is configured to communicate a message to story server 106 indicating that the event or page number has been reached. Story server 106 may be configured to communicate with computing device 102 via a wired network connection or via a wireless connection such as Wi-Fi, a mobile phone communication standard such as 3g or 4g, etc.

In one example, computing device 102 is configured to automatically communicate a location in a story to story server 106 upon detecting that a particular page turn has occurred within an e-book application. Alternatively, computing device 102 may be configured to automatically communicate a location in a story to story server 106 upon user 104 clicking on a button, checkbox, link, etc. within an e-book application to indicate that a location has been reached.

Story server 106 is further configured to communicate a task based on the event or page number. The task can be a video game, a quiz, a request to perform an action, a request to select from two or more options, or other similar type of activity intended to illicit feedback or a response from user 104. For example, when a user reaches a certain event or page in a story, and story server 106 is notified accordingly by computing device 102, story server presents a video game sequence for user 104 to play. In one example, tasks are predefined and associated with predetermined locations or events of a story. In another example, story server 106 is configured to generate tasks in real time, based on information received.

Tasks may illicit various interactions such as clicking, scrolling up or down, keyboard inputs, using body gestures sensed by a motion sensing device, using gestures with a motion sensor controller, audio/voice commands through an audio sensing device, or cursor rolling. These actions may have audio or visual feedback such as color change, art change, animation, sound effects, or music.

Computing device 102 is configured to present the generated task to user 104 via a web browser, a social media application, or other suitable means. For example, computing device 102 may be configured to minimize, or send to the background, an e-book application and automatically launch a web browser to present a video game challenge to user 104 upon the user reaching a certain point in the story. Alternatively, computing device 102 may be configured to present the video game challenge to user 104 directly within the e-book application without launching a second application.

In one example, computing device 102 is configured to offer user 104 an option of skipping or bypassing the task and proceeding with the story without participating in the interactive portion of the story. Thus, computing device 102 may give user 104 the option of determining to what extent user 104 wishes to customize or personalize the story. In one example, computing device 102 may be configured to automatically change pages of a story according to a predefined or user-defined time interval. In another example, computing device 102 may be configured to change pages of a story in response to feedback received from user 104.

Story server 106 is further configured to receive data representative of a response to a task presented to user 104. For example, if a video game challenge has been presented to user 104, story server 106 is configured to receive information indicating whether user 104 completed the challenge successfully. In other words, story server 106 may be configured to receive a “yes” or “no” response to the task. In another example, story server 106 may be configured to receive information indicative of a decision made by user to select a specific choice from a group of options. For example, story server 104 may be configured to receive indication of which one of four doors user 104 chose to open within a video game challenge. In another example, story server 106 may be configured to receive information indicative of how well or how poor user 104 performed in the task. For example, story server 106 may be configured to receive a total point score.

Story server 106 is further configured to determine a next event, or next page, in a story based on how user 104 responds to the task. Thus, an outcome of an interactive story depends on how a reader interacts with and responds to tasks being presented.

It should be understood that story server 106 is capable of determining a next event in a story either at the beginning of a story, in the middle of a story, or at the end of a story. In other words, story server 106 is configured to alter the outcome of a story at any point in the story.

Story server 106 is further configured to communicate a next event or next location in a story to computing device 102. In one example, computing device 102 is configured to receive data representative of the story. In other words, story server 106 is configured to communicate digital media, or the actual media, text, or images of the story, to computing device 102.

In another example, computing device 102 is configured to receive data representative of an event or a location in a story, rather than the actual media, text, or images of the story. For example, computing device 102 may receive an indication to display a specific page number of a story or digital book, instead of receiving the actual content of the digital book. Thus, computing device 102 may be configured to store the digital book locally in internal memory. Computing device 102 is configured to automatically load a corresponding portion of the story according to the received data.

Story server 106 is configured to communicate with a story database 108. Story database 108 is configured to store data that enables story server 106 to provide a user 104 with an interactive experience. For example, story database 108 may be configured to associate various tasks with specific events or locations in a story. In such an example, story server 106 is configured to access story database 108 to retrieve stored information upon receiving a notification that user 104 has reached a specific point in a story, in order to determine a task to present to user 104.

In one example, story database 108 may be configured to store information associated with user 104. User information may include age, sex, geographic data, past purchase history, personal preferences, reading history, and past performance on tasks for example. In one example, story server 106 is configured to receive login credentials from user 104. Story database 108 is also configured to associate various types of user data with user 104 according to the login credentials. Story server 106 is configured to customize a user experience based on the associated data. For example, story server 106 may be configured to associate a determined next event with user 104 and to store the associated information in story database 108. This allows user 104 to take a break from reading an interactive story and to return at a later time. If user 104 provides a login credential upon resuming the interactive story at a later time, story server 106 is configured to retrieve the stored next event and to communicate to computing device 102 the next event. By communicating with story server 106, computing device 102 is able to continue to present the interactive story to user 104 at the same location where user 104 last stopped reading. In one example, any computing capable of presenting an interactive story to a user may communicate with story server 106 in order to continue to present the story to user 104 at the same location where user 104 last stopped reading. In other words, story server 106 is device independent, as long as user 104 provides the same login credentials.

In one example, story server 106 is configured to retrieve the stored next event associated with user 104 upon receiving access credentials of user 104 and to communicate to computing device 102 a next event in a second story based on the associated data. In other words, story server 106 is configured to customize a user's experience with a second book, based on the user's experience with a first book.

In one example, story server 106 is configured to communicate an advertisement to user 104 via computing device 102, based on stored data associated with user 104. For example, computing device 102 is configured to develop marketing strategies and to communicate an advertisement to user 104 based on the types of stories previously read by user 104 or based on how user 104 previously performed on presented tasks. Thus, if user 104 frequently reads Spider Man comic books, for example, story server 106 is configured to identify such a preference and to present an advertisement to user 104 for a new Spider Man comic book, or for another similar comic book.

In one example, story server 106 is configured to calculate a score, or a ranking, for user 104 based on the next events or tasks communicated to user 104. In other words, story server 106 is configured to evaluate the user's performance on presented tasks and assign some value to the performance. Story server 106 is also configured to store the score or ranking in story database 108. Story server 106 is also configured to communicate a reward to user 104 based on the calculated score or ranking. For example, story server 106 may offer user 104 free merchandise or discounts off merchandise at a select store. Story server 106 may also be configured to highlight the user's score or ranking in relation to other users in an online community or social network. For example, story server 106 may be configured to display an online leaderboard showing the top performers in an interactive comic book game.

In one example, story server 106 is configured to enable users to trade with other users in a social network or other similar online community. For example, a user may trade accumulated points with another user in exchange for the other's user's purchased video game story or video game comic book. Users may also agree to exchange video game comic books via story server 106.

In one example, data stored in story database 108 is used to evaluate the interactive story and the tasks presented to improve the story and the tasks in the future. For example, if it is determined that a majority of users fail a particular task or find a particular task unusually challenging, the task can be adjusted for future users to allow for a higher success rate and in turn a better user experience.

It should be appreciated that, although story server 106 and story database 108 are illustrated as independent components of system 100, story server 106 and story database 108 may also be combined to be hosted by a single computer server.

It should be appreciated that system 100 may be configured to facilitate various types of interactive stories and comics including different styles of art and color and written in various languages. In addition, the stories or comics may be partially or fully animated, include audio narration, or include embedded spoken dialogue. The games or tasks presented may include various styles of game play, mechanics, art, and style, and may be programmed in various suitable programming languages.

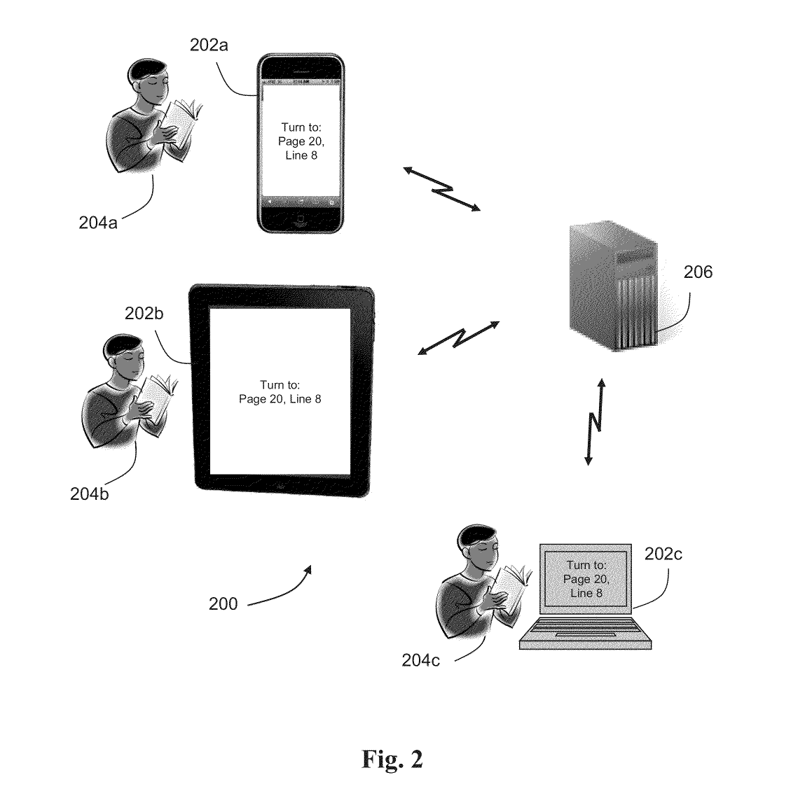

In one example, as illustrated in FIG. 2, computing devices 202a, 202b, and 202c (hereinafter referred to as computing device 202) are configured to communicate location or page numbers of a story to users 204a, 204b, and 204c (hereinafter referred to as user 204), rather than to communicate the actual content of the story, as computing device 102 of FIG. 1 is configured to do. In addition, computing device 202 is configured to communicate with story server 206 in order to provide user 204 with an interactive story experience, similar to the way computing device 102 interacts with story server 106 in FIG. 1. Thus, user 204 may participate in an interactive story experience while reading a printed book. For example, when user 204 reaches a certain page or location in a printed book that prompts user 204 to perform a specific task, user 204 may access computing device 204 to perform the specified task. Computing device 202 is configured to communicate with story server 206 to identify a next page or location based on the user's performance on the task and to communicate the identified page number or location to user 204. User 204 is then able to proceed with the story by turning to the page number, in the printed book, as indicated by computing device 202.

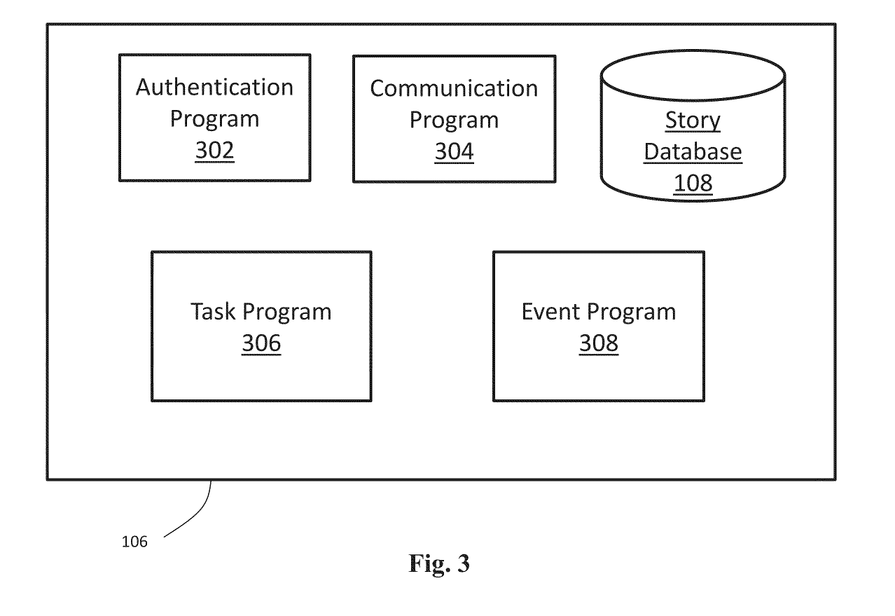

FIG. 3 illustrates a block diagram of an example story server 106. Story server 106 has an authentication program 302 configured to receive authentication credentials of user 104 and to authenticate user 104. Story server 106 also has a story database 108 configured to store authentication credentials and other information about user 104 and the user's 104 experience within an interactive story. By storing such information, authentication program 302 enables story server 106 to create a customized interactive story experience, unique to user 104.

Story server 106 has a communication program 304 that is configured to communicate with computing device 102. For example, communication program 304 is configured to receive data representative of an event or location in a story from computing device 102. Communication program 304 is also configured to communicate a task to computing device 102. Communication program 304 is also configured to receive data representative of a response to the task and to communicate to computing device 102 a next event or location in the story. Communication program 304 is further configured to communicate with story database 108 in order to store and retrieve information about user 104 and about the user's experience within an interactive story.

Story server 106 also has a task program 306 configured to determine a task to present to user 104 based on received data representative of an event or location in a story. The task can be a video game, a quiz, a request to perform an action, a request to select from two or more options, or other similar type of activity intended to illicit feedback or a response from user 104. Tasks may be predefined and associated with predetermined locations or events of a story in story database 108. Alternatively, task program 306 may be configured to generate tasks in real time, based on information received.

Story server 106 also has an event program 308 configured to determine a next event or location in a story based on a user's response or performance on a task. Next events may be predefined and associated with certain responses to tasks and stored in story database 108. Thus, in one example, event program 308 is configured to determine next events in a story by accessing stored information in story database 108. For example, event program 308 may be configured to direct user 104 to turn to a first page if user 104 selects a first option in a presented task and to direct user 104 to turn to a second page if user 104 selects a second option in the presented task, based on information stored in story database 108. Alternatively, event program 308 may be configured to determine next events by performing a calculation or executing an algorithm in real time, based on a response. For example, event program 308 may be configured to compare the user's score on a task to scores achieved by other users, according to a predefined algorithm, and to direct user 104 to a specific page based on the comparison.

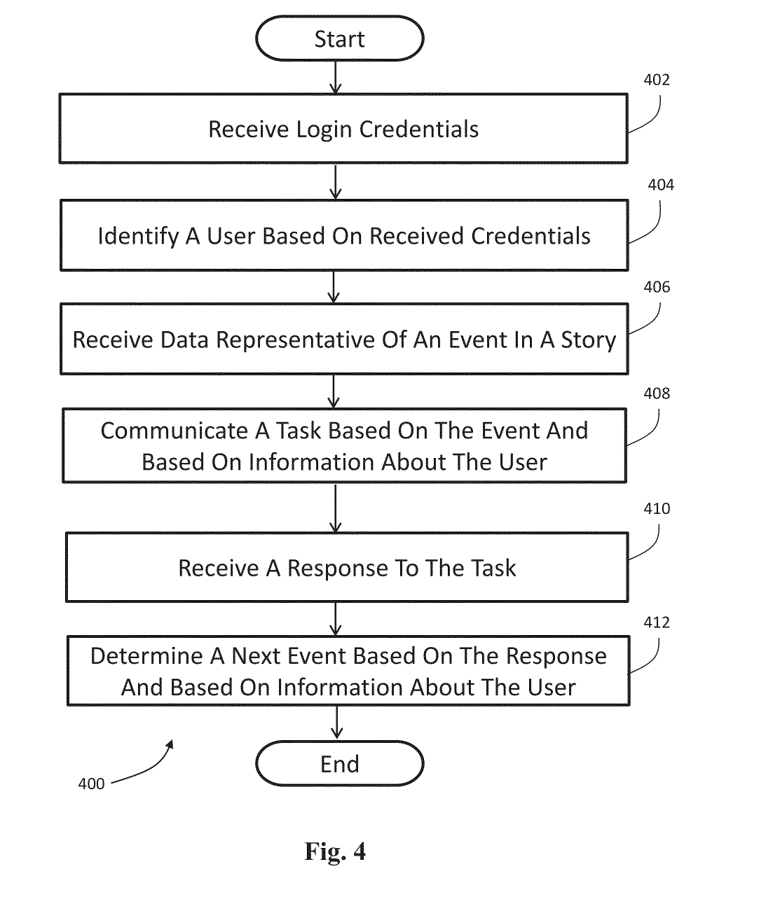

FIG. 4 is a flow chart illustrating an example method for facilitating an interactive story. At step 402, story server 106 receives login credentials of user 104 via computing device 102. At step 404, story server 106 accesses story database 108 to identify user 104 based on received login credentials. In one example, if story server 106 determines that story database 108 doesn't contain login credentials for user 104, story server 106 creates an account for user 104 and stores login credentials and other information about user 104 in story database 108.

At step 406, story server 106 receives data representative of an event in a story. At step 408, story server 106 identifies and communicates a task to be performed by user 104, based information stored about user 104 and based on the user's current location in the story. In other words, story server 106 may communicate a first task to a first user and a second task to a second user, even though both first and second users have reached the same event in the same story. This is because story server 106 is configured to create unique interactive story experiences for each user, based on the user's preferences and past performances on other tasks.

At step 410, story server 106 receives a response to the task from user 104, via computing device 102. The response may be an answer to a question, a selection made from a group of options, an action performed in a video game, or other similar feedback provided by user in response to a presented task.

At step 412, story server 106 determines a next event in a story based on the received response and based on information stored about user 104. In other words, story server 106 may determine a next event for a first user and a different next event for a second user, even though first and second users both reached the same location in a story and both responded identically to the same presented task. This is because story server 106 is configured to create unique interactive story experiences for each user, based on the user's preferences and past performances on other tasks.

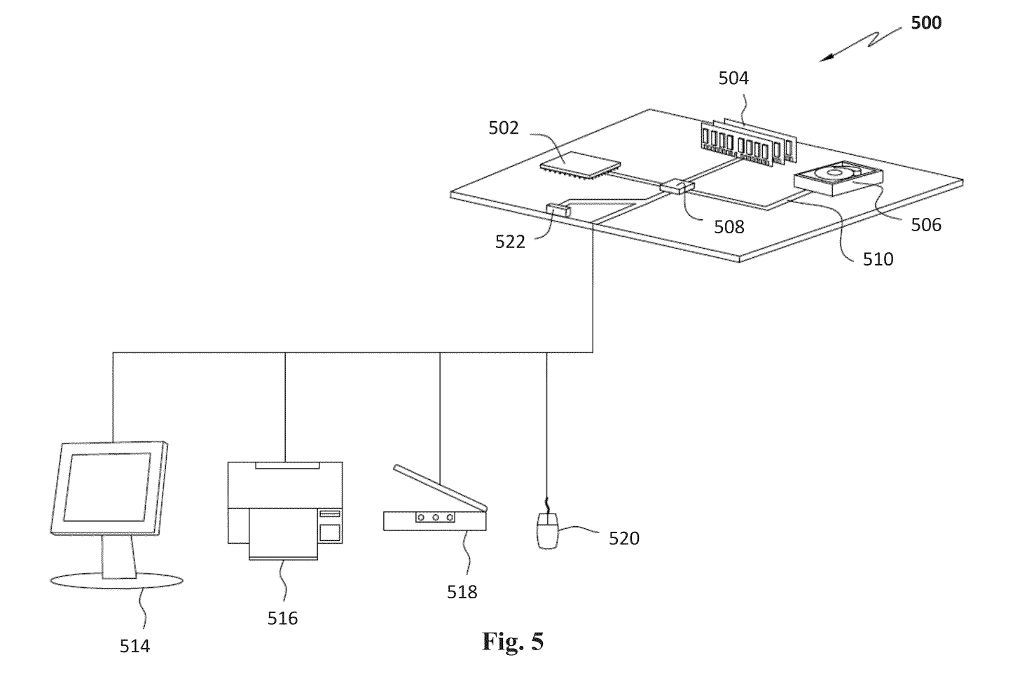

FIG. 5 is a schematic diagram of an example computer for implementing the example system for facilitating an interactive story of FIG. 1 The example computer 500 is intended to represent various forms of digital computers, including laptops, desktops, handheld computers, tablet computers, servers, and other similar types of computing devices. Computer 500 includes a processor 502, memory 504, a storage device 506, and a communication port 508, operably connected by an interface 510 via a bus 512.

Processor 502 processes instructions, via memory 504, for execution within computer 500. In an example embodiment, multiple processors along with multiple memories may be used.

Memory 504 may be volatile memory or non-volatile memory. Memory 504 may be a computer-readable medium, such as a magnetic disk or optical disk. Storage device 506 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 504 or storage device 506.

Computer 500 can be coupled to one or more input and output devices such as a display 514, a printer 516, a scanner 518, and a mouse 520.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Some portions of the detailed descriptions are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

1. A method for facilitating an interactive story, the method comprising the steps of:
a computer receiving data representative of an event in a story, the event corresponding to a first page number of a book;
a computer communicating a task based on the event;
a computer receiving data representative of a response to the task;
a computer determining a next event in the story based on the response; and
a computer communicating a second page number of the book, the second page number corresponding to the next event in the story.

2. The method of claim 1, wherein a task comprises at digital video game.

3. The method of claim 1, further comprising the steps of:
a computer receiving data representative of a user, the data comprising a login credential;
a computer associating data representative of the next event in the story with the data representative of the user; and
a computer storing the associated data;

4. The method of claim 3, further comprising the steps of:
a computer receiving data representative of the login credential; and
a computer retrieving the data representative of the next event in the story based on the login credential.

5. The method of claim 3, further comprising the steps of:
a computer receiving data representative of the login credential;
a computer retrieving the associated data based on the login credential;
a computer determining a next event in a second story based on the associated data; and
a computer communicating a page number of a second book, the page number of the second book corresponding to the next event in the second story.

6. The method of claim 3, further comprising the step of a computer communicating an advertisement based on the stored associated data.

7. The method of claim 1, further comprising the step of a computer communicating digital media corresponding to the next event in the story.

8. The method of claim 1, further comprising the steps of:
a computer calculating a ranking based on the determined next event in the story; and
a computer communicating a reward based on the calculated ranking.

9. The method of claim 8, wherein the step of the computer communicating a reward comprises the computer communicating a product offer corresponding to at least one of a product discount or a free product.

10. A system for facilitating an interactive story, the system comprising:
at least one processor, at least one computer-readable tangible storage device, and program instructions stored on the at least one storage device for execution by the at least one processor, the program instructions comprising:
first program instructions configured to receive data representative of a location in a book;
second program instructions configured to communicate data representative of a task, the task being configured to illicit a response;
third program instructions configured to receive data representative of a response to the task; and
fourth program instructions configured to communicate data representative of a next location in the book based on the response.

11. The system of claim 10, wherein the task comprises a game, and wherein the response comprises playing the game.

12. The system of claim 10, wherein the task comprises a question, and wherein the response comprises an answer to the question.

13. The system of claim 10, the program instructions further comprising:
fifth program instructions configured to receive data representative of a user, the data comprising a login credential;
sixth program instructions configured to associate the data representative of the next location in the book with the data representative of the user; and
seventh program instructions configured to store the associated data.

14. The system of claim 13, the program instructions further comprising:
eighth program instructions configured to receive data representative of the login credential;
ninth program instructions configured to retrieve the data representative of the next location in the book based on the login credential; and
tenth program instructions configured to communicate the retrieved data representative of the next location in the book.

15. The system of claim 13, the program instructions further comprising:
eighth program instructions configured to receive data representative of the login credential;
ninth program instructions configured to retrieve the associated data based on the login credential; and
tenth program instructions configured to communicate data representative of a next location in a second book based on the associated data.

16. The system of claim 13, the program instructions further comprising eighth program instructions configured to communicate an advertisement based on the stored associated data.

17. The system of claim 10, wherein the book is a paper book, wherein the data representative of a location in the book comprises a first page number of the book and wherein the data representative of a next location in the book comprises a second page number of the book.

18. The system of claim 10, wherein the book is a digital book, and wherein the fourth program instructions are further configured to communicate digital media corresponding to the next location in the book.

19. The system of claim 10, the program instructions further comprising:
fifth program instructions configured to calculate a score based on the next location in the book; and
sixth program instructions configured to communicate a reward based on the calculated score.

20. An interactive electronic book reader comprising:
at least one processor, at least one computer-readable tangible storage device, at least one user interface, and program instructions stored on the at least one storage device for execution by the at least one processor, the program instructions comprising:
first program instructions configured to communicate a first portion of a story to the at least one user interface;
second program instructions configured to communicate, to the at least one user interface, a game configured to illicit a feedback by way of the at least one user interface; and
third program instructions configured to communicate a second portion of the story to the at least one user interface based on the feedback.
